(19) United States
(12) Patent Application Publication
(10) Pub. No.: US 2017/0174176 A1
(43) Pub. Date: Jun. 22, 2017

(54) BODY SILL AND ANCHORING DEVICE FOR A SEATBELT IN A VEHICLE BODY ASSEMBLY

(71) Applicant: GM GLOBAL TECHNOLOGY OPERATIONS LLC, Detroit, MI (US)

(72) Inventors: Klaas HILLMANN, Ruesselsheim (DE); Jochen HOFMANN, Ruesselsheim (DE)

(73) Assignee: GM GLOBAL TECHNOLOGY OPERATIONS LLC, Detroit, MI (US)

(21) Appl. No.: 15/383,778

(22) Filed: Dec. 19, 2016

(30) Foreign Application Priority Data
Dec. 18, 2015 (DE) 102015016538.0

(51) Int. Cl. B60R 22/24; B62D 25/02; B60R 22/195

(52) U.S. Cl. CPC B60R 22/24; B60R 22/1951; B62D 25/025; B60Y 2304/05

(57) ABSTRACT

A vehicle body assembly includes a first door sill arrangement and a second door sill arrangement for a motor vehicle. The first door sill arrangement includes a first bodywork section, a first anchoring device for anchoring a seatbelt in the first bodywork section, and a belt tensioner for tightening the seatbelt. The belt tensioner is in operative connection with the first anchoring device. A first trim element covers the first bodywork section. The second door sill arrangement includes a second bodywork section, a second anchoring device for anchoring the seatbelt in the second bodywork section and a second trim element, which covers the second bodywork section.

### CROSS-REFERENCE TO RELATED APPLICATION

This application claims priority to German Patent Application No. 102015016538.0, filed Dec. 18, 2015, which is incorporated herein by reference in its entirety.

### TECHNICAL FIELD

The present disclosure pertains to a vehicle body assembly, and more particularly an assembly for an anchoring device or a seatbelt in a bodywork section of a door sill.

### BACKGROUND

Many motor vehicles are fitted with belt tensioners for tightening a seatbelt, by which an occupant is held securely on a motor vehicle seat. It is known that an anchoring point of the seatbelt and the belt tensioner are arranged on a door sill of the motor vehicle. The seatbelt is connected operatively to the belt tensioner.

DE 60 2005 005 191 B2, for example, describes a belt tensioning arrangement for a seat belt webbing which is attached to a belt anchoring end of a 3-point safety restraint device. A belt anchoring point is located in a zone which is defined as the R14 zone according to the legislation pertaining to belt anchoring arrangements. The belt tensioner has a belt tensioning cylinder with a piston and an extended connector element. The extended connector element is connected to the piston at one end and to the safety belt strap at the other end.

### SUMMARY

The present disclosure provides a vehicle body assembly including a first and a second door sill arrangement, which are constructed with a smaller number of components and at reduced cost. Preferred or advantageous embodiments of the present disclosure are described in the subordinate claims, the following description and/or the accompanying figures.

A vehicle body assembly includes a first door sill arrangement and a second door sill arrangement for a motor vehicle, particularly a motor car or lorry. Preferably, both door sill arrangements may be integrated in the motor vehicle. If necessary, a decision may be made regarding which of the two door sill arrangements is to be integrated in the motor vehicle.

The motor vehicle preferably has an A-pillar and a B-pillar, and a door, for example a driver's door or a front passenger door, is located between the A-pillar and the B-pillar. The motor vehicle is preferably fitted with a seat, e.g., a driver's seat or a front passenger seat, on which an occupant of the motor vehicle may be seated. The seat is preferably located next to the door. Optionally, the motor vehicle is fitted with a seatbelt arrangement including a seatbelt, a belt buckle mechanism and a belt retractor. The seatbelt arrangement is preferably attached to the seat in order to secure the occupant in place on the seat. In particular, the seatbelt is arranged and/or constructed such that it extends laterally to the belt buckle mechanism across the hips of the occupant sitting on the seat. The seatbelt is preferably connected to load-bearing parts of the motor vehicle at three points. For example, at a first point the belt buckle mechanism is arranged on a side of the seat opposite the door. The seatbelt preferably extends from the belt buckle mechanism diagonally over the upper torso of an occupant to the belt retractor, which is integrated in the B-pillar of the motor vehicle as the second point.

The first door sill arrangement includes a first bodywork section and a first anchoring device. The second door sill arrangement includes a second bodywork section and a second anchoring device. The first bodywork section is preferably constructed as a first door sill section, and the second bodywork section is constructed as a second door sill section. In particular, the first and second bodywork sections extend below the door in the lengthwise direction of the motor vehicle. In this particular case, the first and second bodywork sections extend between the A-pillar and the B-pillar of the motor vehicle at least in sections thereof.

The first anchoring device is designed to anchor the seatbelt in the first bodywork section. The second Anchoring device is designed to anchor the seatbelt in the second bodywork section. For this purpose, the anchoring device is preferably coupled to the seatbelt. In particular, an end of the seatbelt which is opposite the belt buckle mechanism and directed towards the door is anchored in the corresponding bodywork section by the first anchoring device or the second anchoring device respectively. In this particular case, a first or second anchoring point located in the bodywork section forms the third point in the motor vehicle at which the seatbelt is secured to the load-bearing parts.

The first door sill arrangement includes a belt tensioner which is designed to tighten the seatbelt, particularly during and/or after a rapid acceleration or sharp deceleration of the motor vehicle. For this purpose, the belt tensioner is in operative connection with the first anchoring device. Particularly preferably, the belt tensioner is provided in the form of a “sill-mounted belt tensioner”. The belt tensioner is designed as a pyrotechnic ignition unit, for example. In particular, the belt tensioner includes a cylinder and a piston that moves relative to the cylinder during and/or after activation.

The second door sill arrangement is designed without a belt tensioner. In particular, the belt, which is anchored in the second bodywork section by the second anchoring device, is not tensioned. The first door sill arrangement includes a first cladding part, and the second door sill arrangement includes a second first cladding part. The first cladding part covers the first bodywork section, and the second cladding part covers the second bodywork section. The first or second bodywork section is preferably covered on the side facing the seat by the corresponding cladding part. The first and second belt tensioners are of identical construction. In particular, the first and second belt tensioner may be swapped with each other without limitation and used to cover the first or second bodywork section.

The advantage of this is that it serves to reduce the number of components in the vehicle body assembly and therewith also costs. In particular, the production and manufacture of the vehicle body assemblies may also be simplified in terms of a smaller number of essential work steps.

In a preferred embodiment of the present disclosure, the first and second belt tensioners each include at least one plastic cladding part of identical construction. Alternatively or optionally in addition thereto, the first and second belt tensioners each include at least one identically shaped fabric part. For example, the shaped fabric part is in the form of a shaped carpet panel.

In a preferred constructive application of the present disclosure, the first bodywork section has a first anchoring interface for the first anchoring device and der second bodywork section has a second anchoring interface for the second anchoring device. For example, the first and second anchoring interfaces each have the form of a hole in the respective bodywork section, though which a screw can be passed.

The first and second anchoring interfaces are particularly preferably arranged identically in terms of their position relative to the belt tensioner. In particular, the first and second anchoring interface reflect each other with regard to their positioning and/or arrangement in the respective bodywork section and relative to the corresponding belt tensioner. Preferably, each of the anchoring interfaces is covered on the side facing the seat by the corresponding belt tensioner.

A first paired interface is preferably assigned to the first anchoring device. The first paired interface is particularly preferably integrated in the belt tensioner. In particular, the first anchoring device is in operative connection with the belt tensioner and consequently anchored together with the belt tensioner in the first anchoring interface.

The second anchoring device preferably has a second paired interface, with which it is anchored in the respective anchoring interface of the corresponding bodywork section.

In a preferred constructive configuration, the first and second paired interfaces are designed as functionally identical and/or structurally identical parts. The first and second paired interfaces preferably each have an eye through which the screw is passed. In particular, the first and second anchoring devices are anchored in the respective anchoring interface of the corresponding bodywork section by a threaded connection.

A preferred variation of the present disclosure provides that the first and second anchoring interfaces are arranged in a “R14 zone” of the motor vehicle. The R14 zone is defined in the legislation that governs belt anchoring arrangements, particularly United Nations Regulation ECE 14-06. According to the pertinent legislation, it is essential for the anchoring of the seatbelt in the bodywork section to be strong enough to sustain loads of at least 15 k.

The first and second bodywork sections preferably have the form of identically constructed first and second door sill sections in the R14 zone defined in the pertinent legislation. In particular, the first and second bodywork section in the R14 zone are identical in shape, size, contour and design. A preferred implementation of the present disclosure provides that the first anchoring device has a first flexible distance element, a first coupling head and the first paired interface. It is further preferred that the second anchoring device have a second flexible distance element, a second coupling head and a second paired interface.

In a preferred embodiment of the present disclosure, the coupling head is arranged on one end of the flexible distance element. It is further preferred that the second paired interface be arranged on one end of the distance element when the distance element is that of the second anchoring device. The flexible distance element may be in form of a steel cable, for example. It is also possible within the scope of the present disclosure that the flexible distance element is enclosed in a sleeve, e.g., covered by a shrink tube. Alternatively, the sleeve may also have the form of a plastic housing.

In the case of the first anchoring device, the flexible distance element is preferably fastened to the piston of the belt tensioner, particularly clamped thereto. In this way, the first anchoring device is operatively connected to the belt tensioner. In particular, the flexible distance element may be drawn into the cylinder when the belt tensioner is activated by the piston, thus tightening the seatbelt.

It is preferred if the coupling head is or can be coupled to the seatbelt. Preferably, the first and second coupling heads are each equipped with a tongue. In particular, the seatbelt is or can be coupled therewith in positive and/or non-positive locking manner. For example, the end of the seatbelt may be sewn to the tongue. Alternatively, the coupling head may include a connector element that partially covers the tongue, wherein a matching part therefor is provided on the end of the seatbelt. The matching part may be inserted into the connector element, and the tongue is engaged in locking manner therein. Alternatively, the matching part may be screwed to the connector element. Optionally, the coupling head may be visible and/or reachable by an occupant sitting on the seat, and preferably not concealed by the belt tensioner.

In a further preferred variation of the present disclosure, the first and second belt tensioners each have a notch for the anchoring device, in particular for the flexible distance element. The flexible distance element of the first and second anchoring devices preferably protrudes through the corresponding notch, so that one part of the flexible distance element, in particular the coupling head, is not concealed by the belt tensioner.

### BRIEF DESCRIPTION OF THE DRAWINGS

The present disclosure will hereinafter be described in conjunction with the following drawing figures, wherein like numerals denote like elements,

FIG. 1 shows a first door sill arrangement of a vehicle body assembly of two door sill arrangements with a first bodywork section and with a first anchoring device, which is anchored in the first anchoring interface of the first bodywork section;

FIG. 2 shows a section of a motor vehicle in which the first or a second door sill arrangement is integrated, wherein the door sill arrangement includes a trim element;

FIGS. 3a, 3b are a top view and an exploded view of a second anchoring device;

FIGS. 4a, 4b are an alternative embodiment of the second anchoring device shown in FIG. 3a, 3b; and

FIG. 5 a second door sill arrangement of the vehicle body assembly, with a second bodywork section and with a second anchoring device which is anchored in a second anchoring interface of the second bodywork section.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

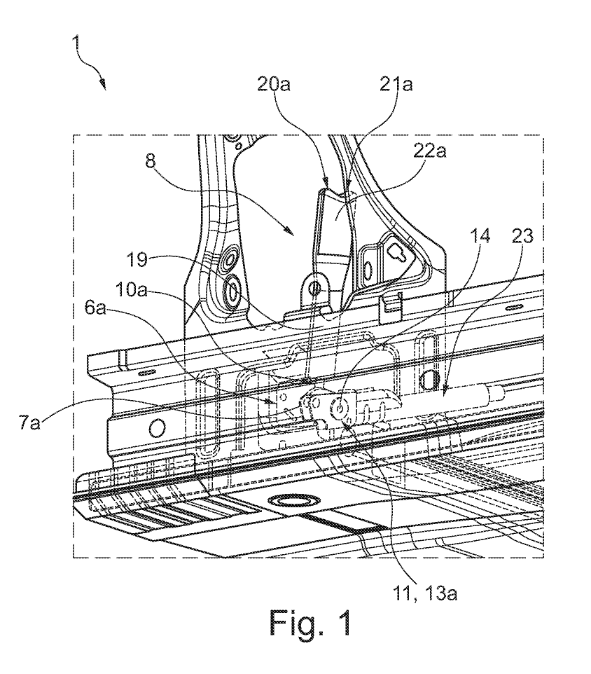

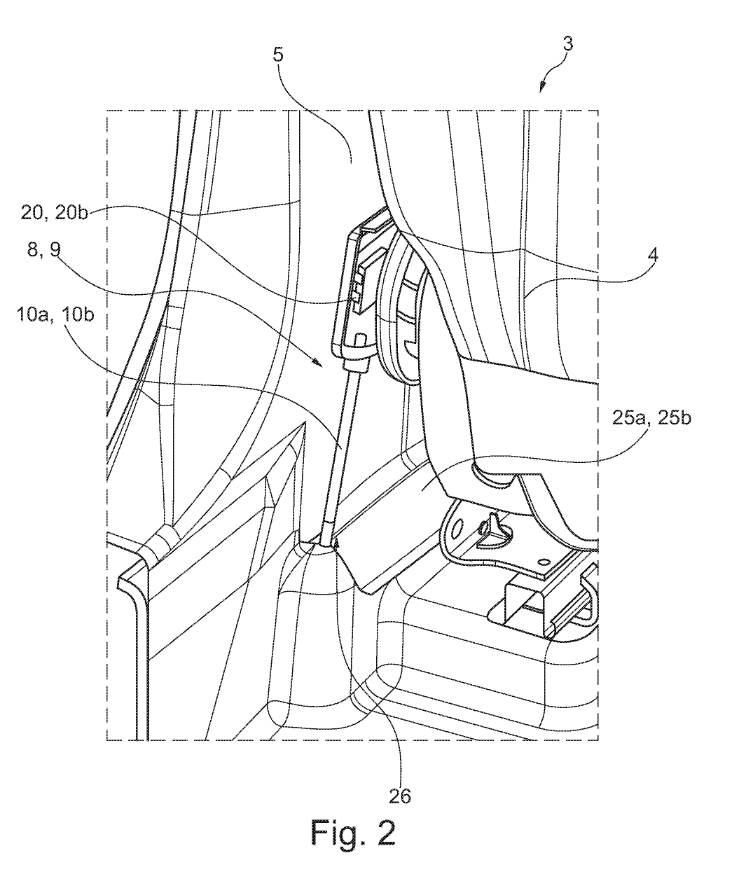

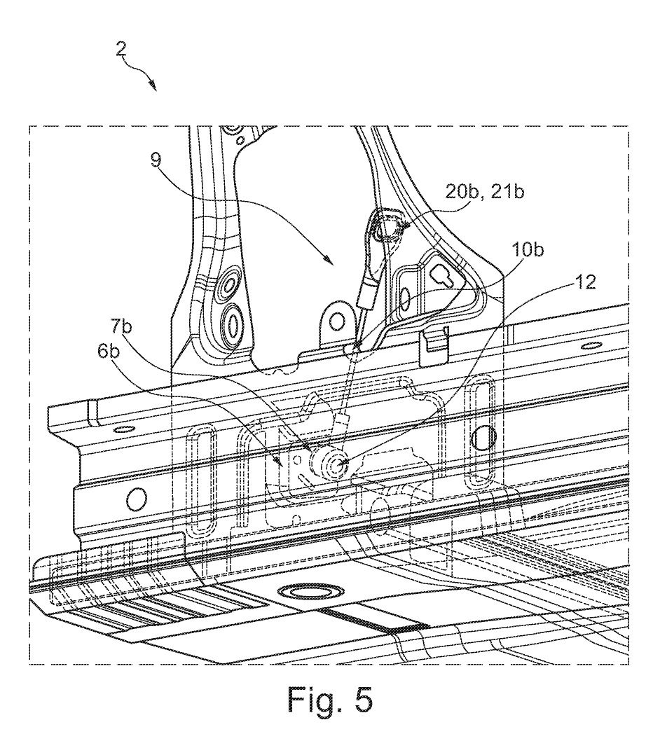

FIG. 1 shows a first door sill arrangement 1, and FIG. 5 shows a second door sill arrangement 2 of a vehicle body assembly consisting of the two door sill arrangements 1, 2. Door sill arrangement 1, 2 are able to be integrated in a motor vehicle 3 (FIG. 2), particularly a motor car or lorry. In this context, it may be integrated in motor vehicle 3 as required, depending on whether or not the motor vehicle is to be equipped with a belt tensioner 23.

A section of motor vehicle 3 with one of the two door sill arrangements 1, 2 is shown in FIG. 2. Motor vehicle 3 has a seat 4, particularly a driver's seat of a front passenger seat. and a B-pillar 5, which is adjoined by a door of motor vehicle 3 (not shown).

As shown in FIGS. 1 and 5, each of the two door sill arrangements 1, 2 includes an identically constructed bodywork section 6a, 6b. As shown in FIG. 1, the first door sill arrangement 1 includes a first anchoring device 8. The second door sill arrangement 2 includes a second anchoring device 9 (FIG. 5). Each of anchoring devices 8, 9 is designed so that an end of a seatbelt of motor vehicle 3 with which an occupant can buckle himself in on the seat, may be anchored in bodywork section 6a, 6b.

Bodywork section 6a, 6b is an identical door sill section in both door sill arrangement 1, 2. It extends below the door from B-pillar 5 in a lengthwise direction of motor vehicle 3. An anchoring interface 7a, 7b in the form of a hole to allow a screw 14 to pass through is provided in each of bodywork sections 6a, 6b. A first anchoring interface 7a is designed to anchor the first anchoring device 8 as shown in FIG. 1. A second anchoring interface 7b is designed to anchor the second anchoring device 9 as shown in FIG. 5. Both anchoring interfaces 7a, 7b are arranged in an “R14 zone” such as is recommended in internationally recognized safety standard specifications.

According to FIG. 1, first anchoring device 8 is anchored in first anchoring interface 7a of a first bodywork section 6a. FIG. 5 shows first anchoring device 8 in the anchored stated in in bodywork section 6b. According to FIG. 5, second anchoring device 9 is anchored in second anchoring interface 7b of second bodywork section 6b.

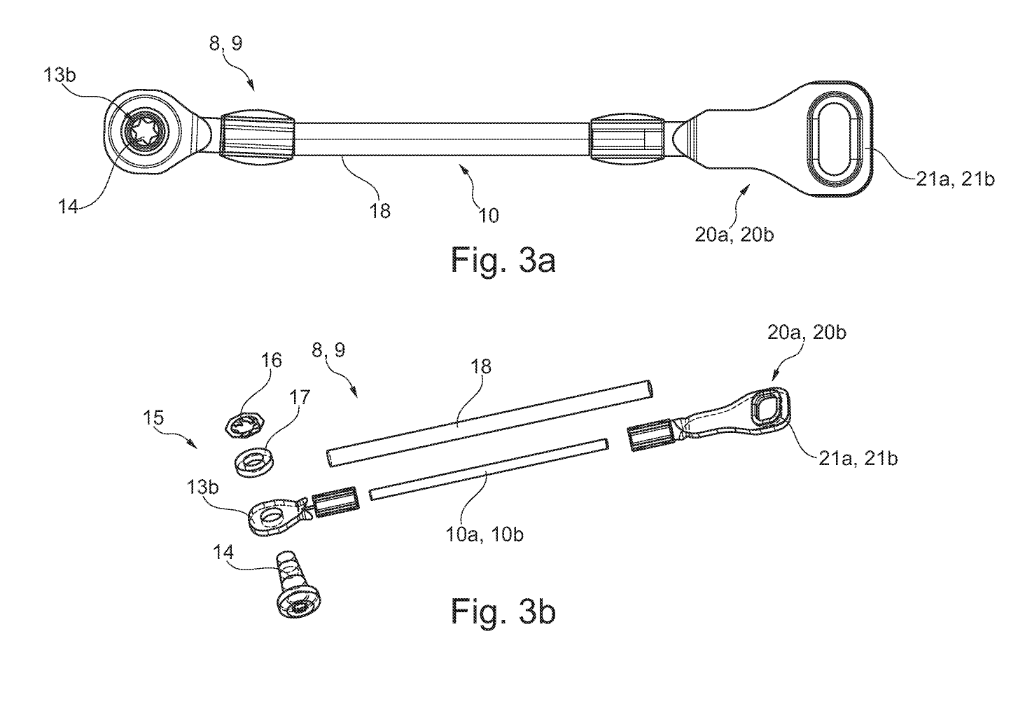

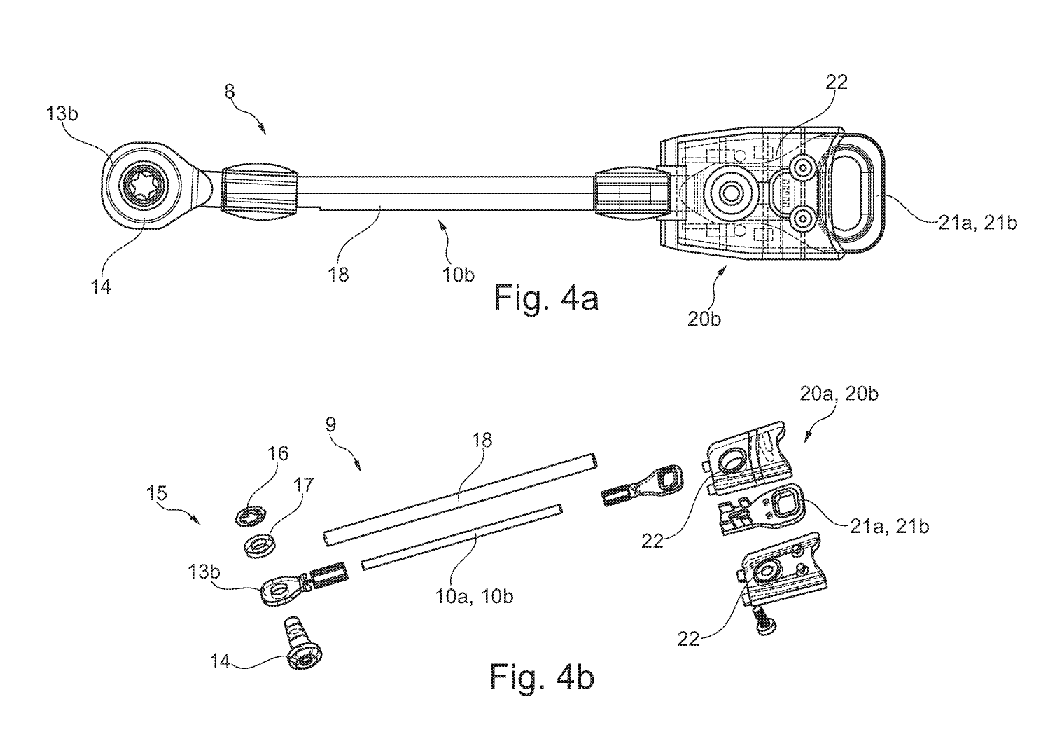

Possible configurations of the first or second anchoring device 8, 9 as shown in a plan view in FIG. 3a and as an exploded diagram in FIG. 3b. FIGS. 4a and 4b show alternative embodiments of the first or second anchoring device 8, 9.

Each of the two anchoring devices 8, 9 includes a flexible distance element 10a, 10b in the form of a steel cable. Flexible distance element 10a of first anchoring device 8 is surrounded by a plastic sleeve 19 (FIG. 1). Flexible distance element 10b of second anchoring device 9 is surrounded by a sleeve 18 (FIG. 3a, 3b, 4a, 4b, 5), which is in the form of a shrink tube.

The first door sill arrangement 1, which is shown in FIG. 1, has a belt tensioner 23. Belt tensioner 23 is designed as a pyrotechnic ignition unit to tighten the seatbelt in the event of rapid acceleration or sharp deceleration of motor vehicle 3. For this purpose, belt tensioner 23 has a cylinder 24 and a piston (not shown) arranged inside cylinder 24. The piston moves relative to cylinder 24 during and/or after activation of belt tensioner 23.

First anchoring device 8 is connected to the piston, e.g., clamped thereto, via flexible distance element 10a. In this way, flexible distance element 10a may be at least partly retracted abruptly into cylinder 24 when the piston moves inside cylinder 24, thereby placing the seatbelt under tension.

Belt tensioner 23 includes a first paired interface 11 for first anchoring interface 7a. The first paired interface 11 is allocated to first anchoring device 8 and has the form of an eye 13 through which screw 14 can be passed. Belt tensioner 23 is anchored in first anchoring interface 7a of first bodywork section 6a together with first anchoring device 8 by threaded connection 15 (FIG. 3a, 3b, 4a, 4b) and through first paired interface 11.

As shown in FIG. 5, second anchoring device 9 has a second paired interface 12 for the second anchoring interface 7b. Second paired interface 12 also includes an eye 13, through which screw 14 can be passed. In particular, each of the two anchoring devices 8, 9 may be anchored in the corresponding bodywork section 6a, 6b by a threaded connection 15. As shown in FIGS. 3b, 4b. threaded connection 15 includes screw 14, a washer 16 and a spacer 17.

Second door sill arrangement 2 is designed without a belt tensioner. In particular, second door sill arrangement 2 has no belt tensioner 23 so that the seatbelt coupled to second anchoring device 9 cannot be tightened in the area of the R-14 zone defined for belt anchors in the legislation, particularly United Nations Regulation ECE 14-06.

Each of the two anchoring devices 8, 9 includes a coupling head 20a, 20b with a tongue 21a, 21b, to which the seatbelt may be fastened in positive and/or non-positive locking manner. For example, first coupling head 20a of first anchoring device 8 as shown in FIGS. 1, 4a, 4b has a connector element 22 which at least partly covers tongue 21a. In this case, a matching part is arranged on the end of the seatbelt and is inserted in connector element 22 so that the tongue is locked in place therein or is secured by a threaded connection. Alternatively, the seatbelt may be sewn to the tongue 21a, 21b of the first and/or second coupling head 20a, 20b, as is shown in FIGS. 3a, 3b and 5. In this case, connector element 22 is not required.

As shown in FIG. 2, each of the two door sill arrangements 1, 2 of the vehicle body assembly has a belt tensioner 25a, 25b. Each belt tensioner 25a, 25b includes a trim element of made of plastic and/or a shaped fabric part, particularly a carpet panel. Belt tensioners 25a, 25b are integrated in the corresponding motor vehicle 3 and cover the respective bodywork section 6a, 6b (FIG. 1, 5) and the respective anchoring interface 7a, 7b on the side facing seat 4.

The positions of first anchoring interface 7a and second anchoring interface 7b of the door sill arrangements 1, 2 relative to trim elements 25a, 25b are the same. This makes it possible for belt tensioner 25a of the first door sill arrangement 1 (FIG. 1) to be constructed identically with belt tensioner 25b of the second door sill arrangement 2 (FIG. 5). The advantage of this is that it serves to reduce the number of components in the vehicle body assembly for Door sill arrangements 1, 2 and so the effort and costs associated with manufacturing and assembly can also be saved.

Belt tensioner 25a, 25b is furnished with a notch 26, through which the corresponding anchoring device 8, 9 protrude—depending on the integration of the first or second door sill arrangement 1, 2 in the motor vehicle—so that coupling head 20a, 20b protrudes from belt tensioner 25a, 25b and the occupant sitting on the seat can reach it. First paired interface 11 (FIG. 1) and second paired interface 12 (FIG. 5) is concealed by the belt tensioner 25a, 25b on the side facing seat 4,

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A vehicle body assembly for a motor vehicle comprising:
a first door sill arrangement having a first bodywork section a first anchoring device for anchoring a seatbelt in the first bodywork section, a belt tensioner operably connected to the first anchoring device for tensioning the seatbelt, and a first trim element, which covers the first bodywork section; and
a second door sill arrangement having a second bodywork section, a second anchoring device for anchoring the seatbelt in the second bodywork section, and a second trim element, which covers the second bodywork section, wherein the second door sill arrangement is constructed without a belt tensioner;
wherein the first and second belt tensioners are identical.

17. The vehicle body assembly according to claim 16, wherein the first belt and second tensioner comprises at least one identically constructed trim element made of plastic and/or at least one identical shaped fabric panel.

18. The vehicle body assembly according to claim 16, wherein the first bodywork section has a first anchoring interface for the first anchoring device, and wherein the second bodywork section has a second anchoring interface for the second anchoring device, wherein the first and second anchoring interfaces are arranged in identical positions relative to the respective belt tensioner.

19. The vehicle body assembly according to claim 18, wherein the first and second anchoring interfaces are arranged in a R14 zone and in an identical position relative to the respective belt tensioner.

20. The vehicle body assembly according to claim 16, wherein the first bodywork section and the second bodywork section have the form of identically constructed first and second door sill section in the R14 zone.

21. The vehicle body assembly according to claim 16, wherein the first anchoring device comprises a first flexible distance element with a first coupling head for coupling with the seatbelt, and a first paired interface for anchoring the seatbelt in the first anchoring interface, wherein the second anchoring device comprises a second flexible distance element with a second coupling head for coupling with the seatbelt, wherein a second paired interface is allocated to the second anchoring device for anchoring the seatbelt in the second anchoring interface.

22. The vehicle body assembly according to claim 21, wherein the first paired interface is arranged on one end of the first distance element, and the first coupling head is arranged on another end of the first distance element.

23. The vehicle body assembly according to claim 22, wherein the second paired interface is arranged on the belt tensioner, and wherein the second coupling head is arranged on one end of the second distance element.

24. The vehicle body assembly according to claim 21, wherein the first and second flexible distance element comprise a first and second steel cable.

25. The vehicle body assembly according to claim 21, wherein the first and second paired interfaces are identical functionally and structurally.

26. The vehicle body assembly according to claim 25, wherein the first and second paired interfaces each comprise an eye, and wherein the first and second anchoring interfaces are each in the form of a hole in the respective bodywork section, wherein a screw is threadably engaged in the eye and the hole for anchoring the first and second anchoring device in the respective bodywork section by a threaded connection.

27. The vehicle body assembly according to claim 21, wherein the first and second coupling heads each have a tongue configured to couple with a seatbelt.

28. The vehicle body assembly according to claim 21, wherein the first and second belt tensioners each have a notch through which the first anchoring device and the second anchoring device respectively protrudes such that the belt tensioner conceals the paired interface and the coupling head, which is revealed, is configured to couple with a seatbelt.
